(19) United States
(12) Patent Application Publication
(10) Pub. No.: US 2015/0177975 A1
(43) Pub. Date: Jun. 25, 2015

(54) ELECTRONIC DEVICE AND METHOD FOR PROVIDING GRAPHICAL USER INTERFACE OF THE SAME

(71) Applicant: Samsung Electronics Co., Ltd., Gyeonggi-do (KR)

(72) Inventors: Jaehak LEE, Gyeongsangbuk-do (KR); Dooyong PARK, Gyeongsangbuk-do (KR); Younggyun LEE, Gyeongsangbuk-do (KR); Gyucheol CHOI, Gyeongsangbuk-do (KR)

(73) Assignee: Samsung Electronics Co., Ltd.

(21) Appl. No.: 14/577,335

(22) Filed: Dec. 19, 2014

(30) Foreign Application Priority Data
Dec. 19, 2013 (KR) 10-2013-0159139

(51) Int. Cl. G06F 3/0484

(52) U.S. Cl. CPC G06F 3/04847

(57) ABSTRACT

A drawing method and an electronic device using the same is provided. The method includes displaying a drawing tool area, including at least one color item and at least one drawing tool item, displaying, on a color mixing area, a first color item and a second color item selected from the drawing tool area, determining whether a request signal for mixing the first color item and the second color item is received, displaying, on the color mixing area, a mixed color generated by mixing the first color item and the second color item, when the request signal is received, and transmitting information related to the drawing tool area and the color mixing area to a second device.

### PRIORITY

This application claims priority under 35 U.S.C. §119(a) to a Korean Patent Application filed on Dec. 19, 2013, in the Korean Intellectual Property Office and assigned Serial No. 10-2013-0159139, the entire disclosure of which is incorporated herein by reference.

### BACKGROUND

1. Field of the Invention

The present invention relates generally to an electronic device and a method for providing a graphical user interface, and more particularly, to a method for providing a graphical user interface capable of intuitively selecting a color and performing a drawing, and an electronic device using the same.

2. Description of Related Art

Recently, due to a rapid increase in the availability of various electronic devices, electronic devices have become a necessity of modern life. A portable terminal is as an example of such electronic devices. The portable terminal can provide various supplementary services, such as a drawing service that draws pictures through a graphical user interface (GUI) provided by the portable terminal, as well as communication services, and various kinds of data transmission services. Accordingly, the portable terminal has been transformed into a multi-functional communication device.

In the conventional art, when a drawing service is provided on a portable terminal, the portable terminal generally displays, through its GUI, a color selection area, including various colors which allow a user to select a desired color for use in drawing a picture. However, when the user selects a desired color, it is difficult to intuitively recognize the location of the desired color in the color selection area. Further, since the user must select a color from among pre-stored colors, the user doesn't have a wide range of choices from which to select, and as a result, the color of picture to be drawn is limited. In addition, the user may be presented with space constraints when drawing a picture, since a picture is generally drawn on a single device without interworking with other devices, and is thus limited by the space constraints of the device.

### SUMMARY

The present invention has been made to address at least the problems and disadvantages described above, and to provide at least the advantages described below.

Accordingly, an aspect of the present invention is to provide a method for drawing and an electronic device using the same.

In accordance with an aspect of the present invention, a drawing method is provided. The drawing method includes displaying a drawing tool area, including at least one color item and at least one drawing tool item, displaying, on a color mixing area, a first color item and a second color item selected from the drawing tool area, receiving a request signal for mixing the first color item and the second color item, displaying, on the color mixing are, a mixed color generated by mixing the first color item and the second color item, when the request signal is received, and transmitting information related to the drawing tool area and the color mixing area to a second device.

In accordance with another aspect of the present invention, an electronic device is provided. The electronic device includes a touch screen configured to display a drawing tool area, including at least one color item and at least one drawing tool item, display, on a color mixing area, a first color item and a second color item selected from the drawing tool area, and display a mixed color generated by mixing the first color item and the second color item on the color mixing area, when a request signal is received, a controller configured to control the electronic device to receive the request signal for mixing the first color item and the second color item, and a wireless communication unit configured to transmit information related to the drawing tool area and the color mixing area to a second device.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a configuration of a portable terminal, according to an embodiment of the present invention;

FIG. 2 is a block diagram illustrating a configuration of a touch screen of a portable terminal, according to an embodiment of the present invention;

FIG. 3 is a diagram illustrating a drawing tool area and a color mixing area of a portable terminal, according to an embodiment of the present invention;

FIG. 4 is a diagram illustrating an example of mixing colors in a color mixing area of a portable terminal, according to an embodiment of the present invention;

FIGS. 5 to 7 are diagrams illustrating examples of controlling a concentration of color when mixing colors in a color mixing area of a portable terminal, according to an embodiment of the present invention;

FIG. 8 is a diagram illustrating an example of selecting a color of a drawing input tool of a portable terminal, according to an embodiment of the present invention;

FIG. 9 is a diagram illustrating an example of transferring a color mixture of a portable terminal to other device, according to an embodiment of the present invention;

FIG. 10 is a flowchart illustrating a process of displaying a mixed color of a portable terminal, according to an embodiment of the present invention; and

FIGS. 11A to 11C are flowcharts illustrating a process of selecting a method of controlling a color concentration when mixing colors in a portable terminal, according to an embodiment of the present invention.

### DETAILED DESCRIPTION OF EMBODIMENTS OF THE PRESENT INVENTION

Embodiments of the present invention are described more fully with reference to the non-limiting embodiments that are illustrated in the accompanying drawings and detailed in the following description. The same reference numbers are used throughout the drawings to refer to the same or like parts. Detailed descriptions of well-known functions and structures incorporated herein are omitted to avoid obscuring the subject matter of the present invention.

An electronic device can be a device that includes a communication function and a display function. For example, the electronic device can include at least one of a smart phone, a tablet personal computer, a mobile phone, a video phone, an e-book reader, a desktop personal computer, a laptop personal computer, a netbook computer, a personal digital assistant (PDA), a portable multimedia player (PMP), an MP3 player, a mobile medical device, a camera, or a wearable device (e.g., a head-mounted-device (HMD), such as electronic glasses, an electronic garment, an electronic bracelet, an electronic necklace, an electronic appcessory, an electronic tattoo, or a smart watch).

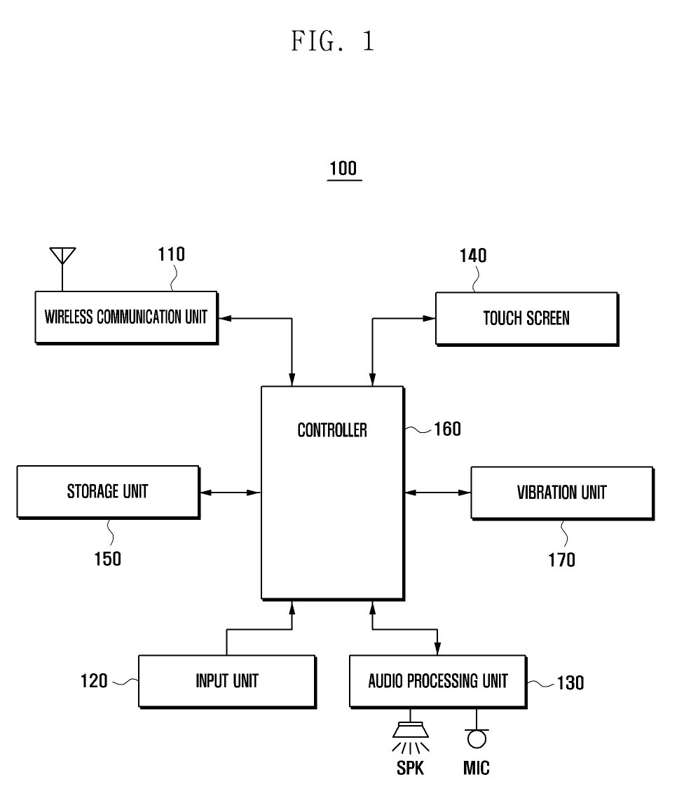

FIG. 1 is a block diagram illustrating a configuration of a portable terminal, according to an embodiment of the present invention.

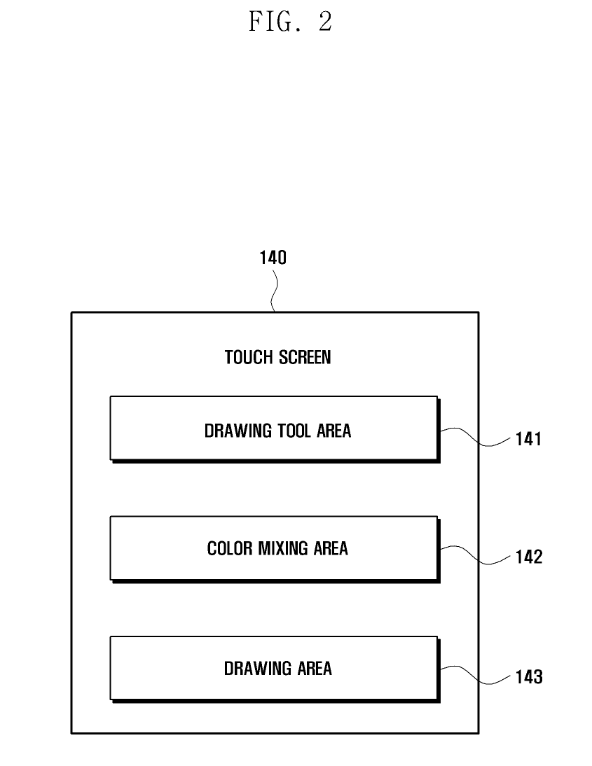

FIG. 2 is a block diagram illustrating a configuration of a touch screen of a portable terminal, according to an embodiment of the present invention.

Referring to FIGS. 1 and 2, the portable terminal 100 includes a wireless communication unit 110, an input unit 120, an audio processing unit 130, a touch screen 140, a storage unit 150, a controller 160, and a vibration unit 170. Since all of the constituent elements shown in FIG. 1 are not essential, a portable terminal having more than the above-mentioned constituent elements or having less than the above-mentioned constituent elements can be implemented.

The wireless communication unit 110 is a communication module to support a mobile communication service of the portable terminal 100. The wireless communication unit 110 forms a communication channel with a mobile communication system. To this end, the wireless communication unit 110 includes a wireless frequency transmission unit for up-converting and amplifying a frequency of a transmitted signal, and a reception unit for low-noise amplifying and down-converting a frequency of a received signal.

In addition, the wireless communication unit 110 includes at least one module which enables a wireless communication between the portable terminal 100 and a wireless communication system or between the portable terminal 100 and a network in which other mobile terminal is located. For example, the wireless communication unit 110 can include at least one of a broadcast receiving module, a mobile communication module, a wireless Internet module, a short-range communication module, and a location information module.

The wireless communication unit 110, according to an embodiment of the present invention, transmits information related to at least one of a drawing tool area 141, a color mixing area 142, and a drawing area 143, to another electronic device (e.g., a portable terminal, a tablet PC, etc.).

The information transmitted by the wireless communication unit 110 can include information which is generated while mixing the colors in the drawing tool area 141 and the color mixing area 142, and can include information related to an image and a text shown in the drawing area 143.

In addition, the information transmitted by the wireless communication unit 110 can include information related to an adjustment of concentration of a first and a second color item stored in the portable terminal 100. The color item refers to a color (e.g., red, orange, green, blue, etc.). The information related to the adjustment of concentration can include information related to a determination of a ratio between the concentration of color items, and information related to a ratio between a non-uniform mixture of a concentration of a first color item and a concentration of a second color item. In addition, the information related to the adjustment of concentration can include information related to a change of at least one of hue, brightness, saturation, and tone of the first color item.

In this case, the method of transmitting and receiving information and data by the wireless communication unit 110 is performed by the wireless communication unit 110. However, information and data can also be transmitted through a connection of direct and physical interface units.

The method of transmitting information between devices can include transmitting information stored in one device to multiple devices, as well as transmitting information stored in one device to another device. For example, information stored in one device and related to at least one of a drawing tool area 141, a color mixing area 142, and a drawing area 143, can be transmitted to multiple devices.

In addition, for example, the drawing area 143, which requires an input area large enough for a user to draw a picture, can be displayed in an electronic device having a large screen, while the drawing tool area 141 and the color mixing area 142, which display supplemental information when user draws a picture can be transmitted to and displayed in an electronic device having a small screen. In this case, the screen size of each electronic device can be determined by exchanging between each other, a batch number or a serial number to recognize the screen size.

The input unit 120 can include a plurality of input keys and function keys for receiving number or character information and setting various functions. The function keys can include a direction key, a side key, and a shortcut key set to perform a specific function. In addition, the input unit 120 generates a key signal related to a user setting and a function control of the portable terminal 100 and transmits the generated key signal to the controller 160.

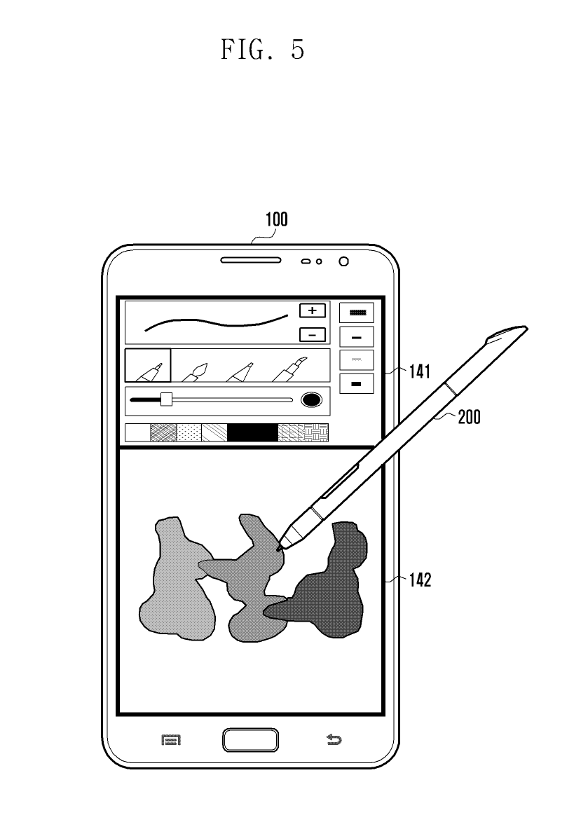

According to an embodiment of the present invention, the input unit 120 can receive an input using an input tool 200, as shown in FIG. 5. In addition, the input unit 120 can detect an input and a selection of colors by, for example, a general pen, a pressure of a user touch, a touch using an electromagnetic induction, a selection by a pre-stored algorithm, as well as by the input tool 200.

The audio processing unit 130 includes a speaker SPK to output an audio signal transmitted from the controller 160 and a microphone MIC to collect an audio signal, according to the activation of a specific application of the portable terminal 100. The audio processing unit 130 outputs audio signals received through the wireless communication unit 110, when the wireless communication unit 110 is activated.

The touch screen 140 displays information provided by a user or information provided to a user, as well as various menus of the portable terminal 100. That is, the touch screen 140 can provide various screens, such as a standby screen, a menu screen, a message writing screen, a call screen, and the like, according to a use of the portable terminal 100. The touch screen 140 can be formed of a Liquid Crystal Display (LCD), an Organic Light Emitting Diode (OLED), or the like. Further, the touch screen 140 can be provided with a touch sensor. In addition, the portable terminal 100 can provide various menu screens that can be accessed using the touch screen 140.

According to an embodiment of the present invention, as shown in FIG. 2, the touch screen 140 can display a drawing tool area 141, a color mixing area 142, and a drawing area 143.

The drawing tool area 141 includes a color item and a drawing tool item. The color item can include colors such as red, orange, green, blue, and the like. Each color item can be an item which is displayed by using a previously stored code, algorithm, data, application, and the like corresponding to each color. In addition, the touch screen 140 can display drawing tool items including a type, a thickness, and the like of the input tool 200. In this case, the color item and the drawing tool item can be updated so that those items can be additionally changed and displayed.

According to an embodiment of the present invention, the touch screen 140 can display a first color item and a second color item on a different location of the color mixing area 142.

The touch screen 140 can change at least one of a hue, brightness, saturation, and tone of a first color item to change the first color item into a second color item, and display a set of colors which is a gradual change of the first color item due to the change. In this case, the gradual change can mean, for example, the arrangement of the change of the first color item which varies according to the change of the brightness in the first color item. The touch screen 140 can display an output of gradation effect when displaying the set of colors.

In addition, the touch screen 140 displays color items selected in the drawing tool area 141 on the color mixing area 142, and can display color items mixed by a mixing command signal. Further, the touch screen 140 can generate and display a third color item, a fourth color item, a fifth color item, and the like, through a re-mixing of a color item with another color item or with an already mixed color item.

The color items created by such a method can be stored by a pre-stored method or can be selectively stored by the user. Information related to color mixing area 142 stored by such a method can be edited (e.g., store, change, delete, etc) by the controller 160.

The drawing area 143 is an area in which user can display an image or a text. In addition, for example, the drawing tool area 141 and the color mixing area 142 can simulate squeezing and mixing paints as when painting with watercolors or painting in oils, and the drawing area 143 can serve as a canvas on which a user can draw a picture.

The drawing tool area 141, the color mixing area 142, and the drawing area 143 can be displayed in different devices respectively. For example, the drawing tool area 141 and the color mixing area 142 can be displayed on portable terminal 100, and the drawing area 143 can be displayed on another device. A user can perform a drawing on the device in which the drawing area 143 is displayed, by using the colors item and the drawing tool item displayed in the drawing tool area 141 and the color mixing area 142 of the portable terminal 100.

Alternatively, the drawing tool area 141, the color mixing area 142, and the drawing area 143 can all be displayed on portable terminal 100. When being displayed on only portable terminal 100, the drawing tool area 141, the color mixing area 142, and the drawing area 143 can be displayed on one screen, or alternatively, each area can be displayed on a different screen through the movement of the screen displayed on a touch screen 140 by a user's input (e.g., drag, touch, flip, flick, and the like).

For example, in a first screen displayed on the touch screen 140, colors are generated and mixed from the drawing tool area 141 and the color mixing area 142 and displayed. In addition, the drawing area 143 can be displayed on another screen which is different from the first screen displayed on the touch screen 140. In addition, the size and location of the drawing tool area 141, the color mixing area 142, and the drawing area 143 can be controlled and edited by the user.

The storage unit 150 stores applications, a key map, a menu map, and the like, for the operation of the touch screen 140, as well as applications for a function operation of the portable terminal 100, according to an embodiment of the present invention. In this case, the key map and the menu map can have various forms.

That is, the key map can be a keyboard map, 3*4 key map, or a QWERTY key map, etc. The key map can also be a control key map for controlling operation of an application which is currently activated. In addition, the menu map can be a control key map for controlling the operation of the application that is currently activated. In addition, the menu map can be for controlling the operation of the application that is currently activated, and can have various menu items provided by the portable terminal 100. The storage unit 150 can include a program area and a data area.

The program area can store an Operating System (OS) for the booting of the portable terminal 100 and the operation of the above-mentioned configurations, an application, for example, an application for supporting a call function of the portable terminal 100, a web browser for connecting to an Internet server, a MP3 application for playing music, an image output application for displaying photos, and a video play application.

According to an embodiment of the present invention, the storage unit 150 can store a drawing program. The drawing program can be a program to store and control information related to at least one of the drawing tool area 141, the color mixing area 142, or the drawing area 143. A program that displays the drawing tool area 141 and the color mixing area 142 can be a program that controls a color item and the form and size of the input tool 200.

The data area is an area in which a data generated according to use of the portable terminal 100 is stored. The data area can store phone book information, at least one icon according to a widget function, and various contents. According to an embodiment of the present invention, the data area can also store information related to the area that is changed by a stimulation (e.g., touch, pressure, electromagnetic induction, etc.) that is input through the touch screen 140.

The controller 160 performs an initialization process by controlling a power supply to each configuration of the portable terminal 100, and controls each configuration when the initialization process is completed.

According to an embodiment of the present invention, the controller 160 can determine a mixture input of a first color item and a second color item. The controller 160 can adjust the concentration of the first color item and the concentration of the second color item by receiving the mixture input. Here, the concentration can refer to a ratio of an amount of hue, brightness, saturation, and tone per unit area of a color item.

According to an embodiment of the present invention, the controller 160 can change at least one of a hue, brightness, saturation, or tone of a first color item to change a first color item into a second color item. Further, when creating a mixed color item, the controller 160 can determine a constant ratio of the first color item to the second color item by uniformly adjusting the concentrations of the first color item and the second color item. For example, the controller 160 determine a constant ratio, such as 1:1, 2:3, 3:5, by detecting user input for a ratio of the first color item to the second color item.

In addition, the controller 160 can adjust the concentration ratio of the first color item and the second color item by un-uniformly mixing the first color item and the second color item. In this case, the un-uniformly mixing of the first color item and the second color item means that the first color item and the second color item are not mixed with a ratio determined by user, and that the concentration ratio of the first color item to the second color item cannot be controlled arbitrarily by user.

The vibration unit 170 performs various vibrations under the control of the controller 160. To this end, the vibration unit 170 includes at least one vibration motor. The vibration unit 170 can receive a call signal in a silent vibration mode, according to a user setting, and can be activated when an alarm time occurs.

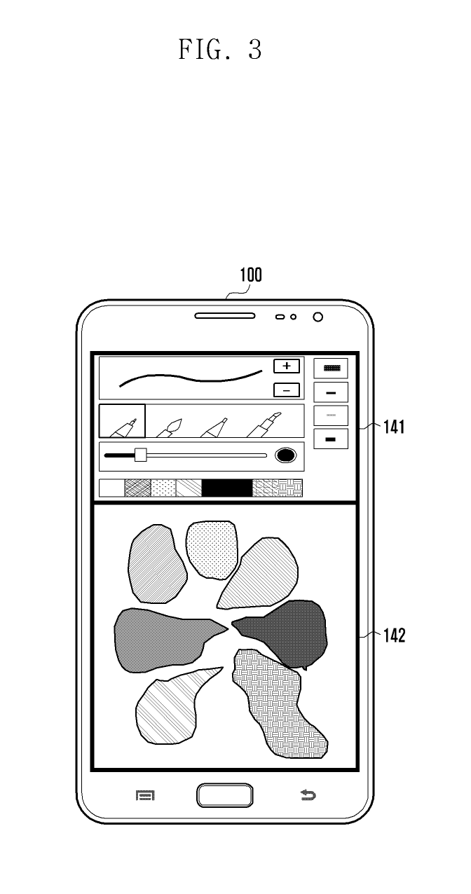

FIG. 3 is a diagram illustrating a drawing tool area and a color mixing area of a portable terminal, according to an embodiment of the present invention.

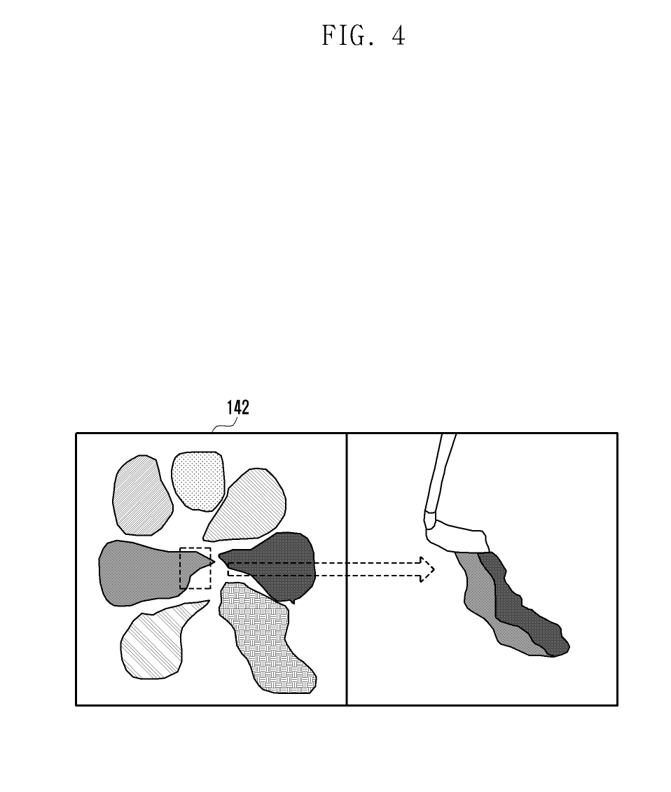

FIG. 4 is a diagram illustrating an example of mixing colors in a color mixing area of a portable terminal, according to an embodiment of the present invention.

Referring to FIGS. 3 and 4, a user can generate a separate color item by mixing color items. For example, in the process of mixing the color items, the colors can be mixed with a proportion including at least one of hue data, brightness data, saturation data, and tone data per unit area of the first color item, and due to an affection of at least one of forms of the input tool 200.

For example, hue data, brightness data, saturation data, or tone data for a color item is selected by user. If a user selects brightness data of a color item as 20 lux, the touch screen 140 displays the color item with a brightness of 20 lux.

In addition, in the process of mixing the color items, the color items can be mixed based on at least one of a pressure intensity of the input tool 200 for the touch screen 140, a pressure duration time of the input tool 200 for the touch screen 140, and a sensitivity of pressure input to the touch screen 140. The mixture of the color items can include not only a one-on-one mixture, but also a mixture of multiple color items with a single color item.

In addition, the color items can be mixed using the input tool 200, based on the type of drawing display area (e.g., the sensitivity of the touch screen, or the touch input method used), the type of pressure applied while mixing a color item (electromagnetic induction, variable pressure touch, strength, type, etc), and the duration of the touch input of the input tool 200.

FIGS. 5 to 7 are diagrams illustrating examples of controlling a concentration of color when mixing colors in a color mixing area of a portable terminal, according to an embodiment of the present invention.

Referring to FIG. 5, the touch screen 140 can display the selected first color item and the second color item, and the controller 160 can non-uniformly mix the concentration of the first color item and the second color item when generating a mixed color item. The non-uniformly mixed color item can be displayed by the touch screen 140.

Here, the non-uniformly mixing of the color item means that the color item is not mixed with a ratio determined by the user, and that the concentration ratio of the first color item and the second color item cannot be controlled arbitrarily by user.

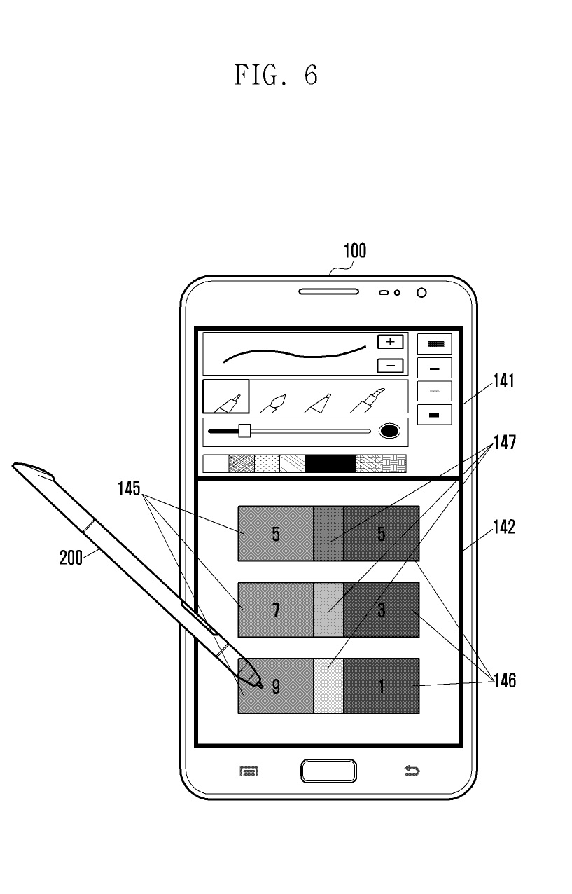

Referring to FIG. 6, the touch screen 140 can arrange and display first and second color items selected from the drawing tool area 141. In addition, the touch screen 140 can arrange and display a mixed area of a third color item in which the first color item 145 and second color item 146 are overlapped. The controller 160 can control at least one of the first color item or the second color item. The touch screen 140 can display a first color item 145 and a second color item 146 by detecting input on the first color item 145 and second color item 146. The controller 160 can determine a mixture ratio for mixing each of the first color item and the second color item by detecting user input. For example, the controller 160 can generate a third color item 147 having a mixture ratio of 5:5, 7:3, and 9:1, with respect to a ratio of the selected first color item 145 to the second color item 146. In addition, the color mixed and displayed in the color mixing area 142 can be stored in the storage unit 150, or can be transmitted to another electronic device by the wireless communication unit 110.

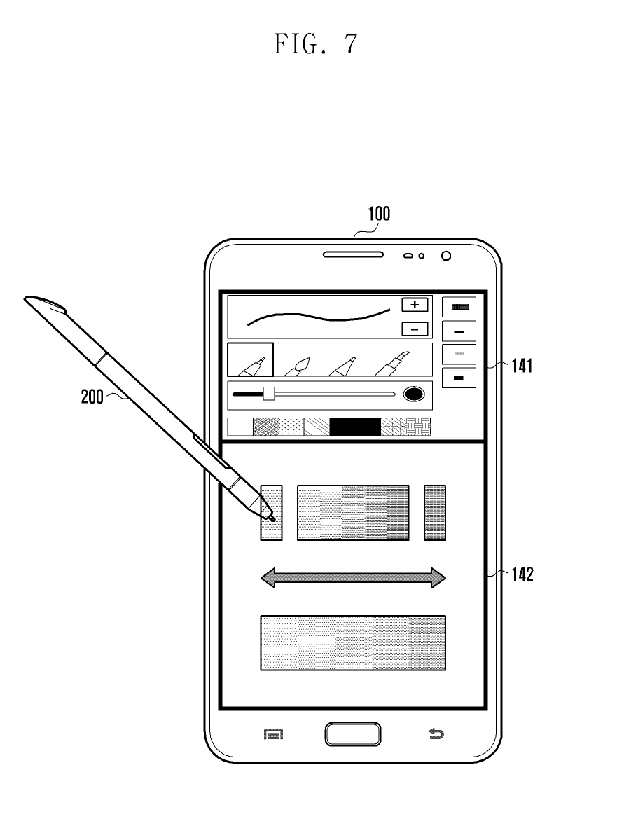

Referring to FIG. 7, the touch screen 140 can display the first color item and the second color item in separate locations of the color mixing area 142, and the controller 160 can change at least one of a hue, brightness, saturation, and tone of the first color item to change the first color item into the second color item. Then, the touch screen 140 can display a set of colors which is a stepwise change of the first color item according to the change.

The touch screen 140 can display the first color item in a certain area A in the color mixing area 142 and can display the second color item in a certain area C in the color mixing area 142. The touch screen 140 can display and connect the area A to the area C. One color can be changed to another color by changing at least one of a hue, brightness, saturation, and tone of the color to be changed. For example, the connection between the area A and the area C can be displayed sequentially on the touch screen 140, such as changing progress from one color to another color.

The touch screen 140 can display a generated set of colors which becomes the second color item by changing at least one of a hue, brightness, saturation, and tone of the first color item. The touch screen 140 can display a gradation effect.

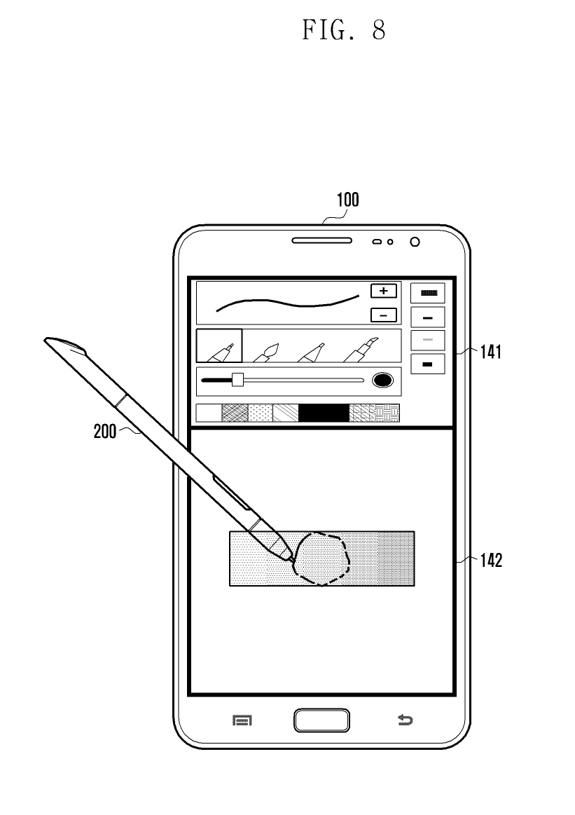

FIG. 8 is a diagram illustrating an example of selecting a color of a drawing input tool of a portable terminal, according to an embodiment of the present invention Referring to FIG. 8, a color of the input tool 200 may be selected from the generated set of colors described with reference to FIG. 7. To select the input tool 200 color, the user may draw a trajectory around the desired color on the generated set of colors. The trajectory is identified from a contact starting point, made by the input tool 200 or by a touch pressure, to a contact ending point, resulting from a contact release of the input tool 200 or the touch pressure. The set of colors within the area of the trajectory is determined as the color of the input tool 200 or an input portion of a tool for drawing a picture. Further, the color of the input tool 200 can be determined as a mixed color or as a single color.

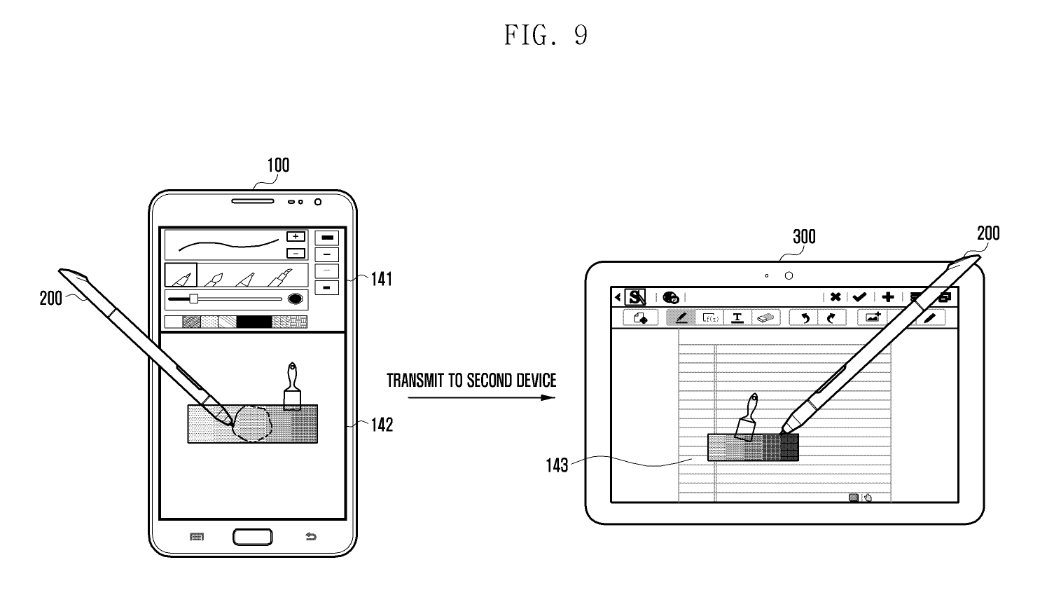

FIG. 9 is a diagram illustrating an example of transferring a color mixture of a portable terminal to other device, according to an embodiment of the present invention.

Referring to FIG. 9, the portable terminal 100 can transmit information related to at least one of the drawing tool area 141, the color mixing area 142, and the drawing area 143 to a second device 300. Here, the information can include information of the drawing tool area 141 and the color mixing area 142, related to a mixture of color item, and can include a wired/wireless communication data, routine, or code related with a connection between the portable terminal 100 and the second device 300.

In addition, the information can include information related to the adjustment of the concentration of the first color item and the concentration of the second color item in the portable terminal 100. In this case, the information related to the adjustment of the concentrations can include information of a particular ratio between color items, such as 1:1, 2:3, 4:5, and information of changing at least one of hue, brightness, saturation, or tone of the first color item.

Further, for the convenience of the connected two devices, a device having a wide screen can be displayed as the drawing area 143, and a device having a small screen can be displayed as the color mixing area 142. This can be provided by sharing screen size information between the two connected devices.

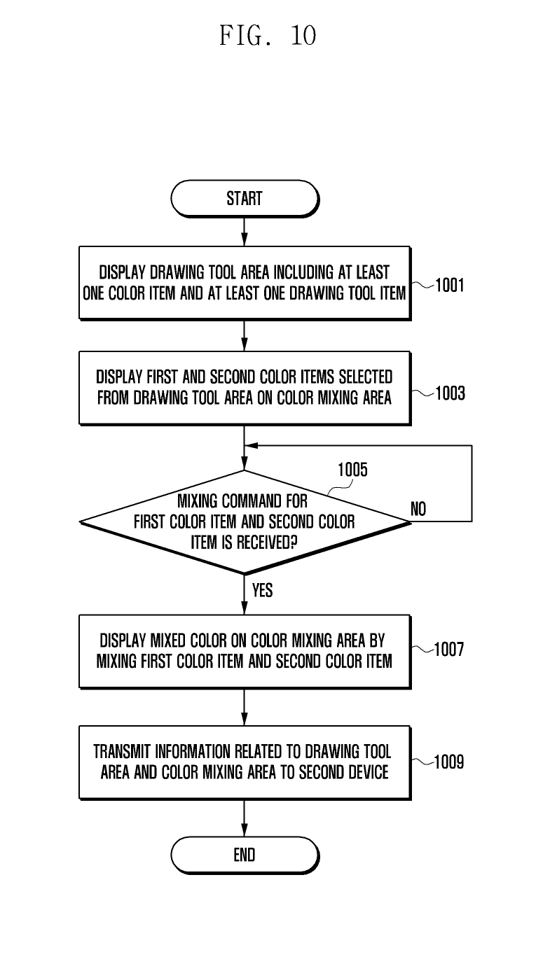

FIG. 10 is a flowchart illustrating a process of displaying a mixed color of a portable terminal, according to an embodiment of the present invention.

Referring to FIG. 10, the touch screen 140 displays the drawing tool area 141 including at least one color item and at least one drawing tool item at step 1001. The touch screen 140 displays first and second color items selected from the drawing tool area 141 on the color mixing area 142 at step 1003. The selection of the first and second color items can be received by a user's selection input, or by a previously stored method.

At step 1005, the controller 160 determines whether a mixing command for the first color item and the second color item displayed on the color mixing area 142 is received. This can include a mixing command by a user's touch or by an input tool 200 through a previously stored method. At step 1007, when it is determined that the mixing command is received, the touch screen 140 displays the mixed color of the first color item and the second color item, on the color mixing area 142.

The wireless communication unit 110 transmits information related to the drawing tool area 141 and the color mixing area 142 to another device at step 1009. Here, the information related to the drawing tool area 141 and the color mixing area 142 includes information related to a color item which is mixed depending on user's mixing command.

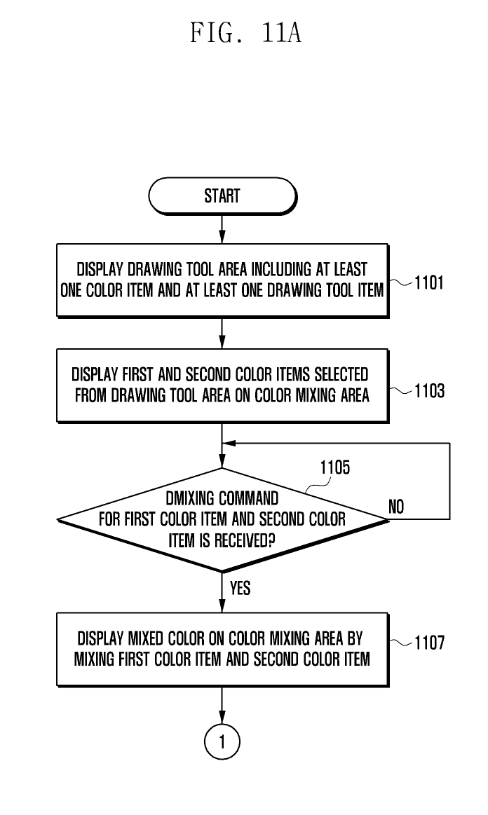

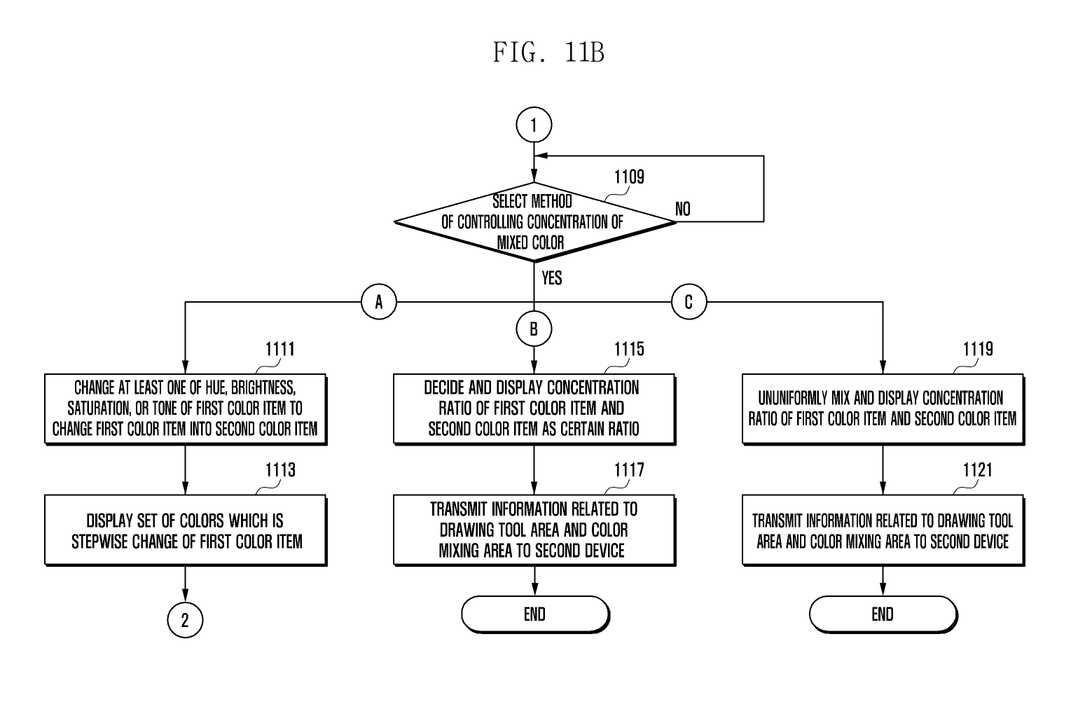

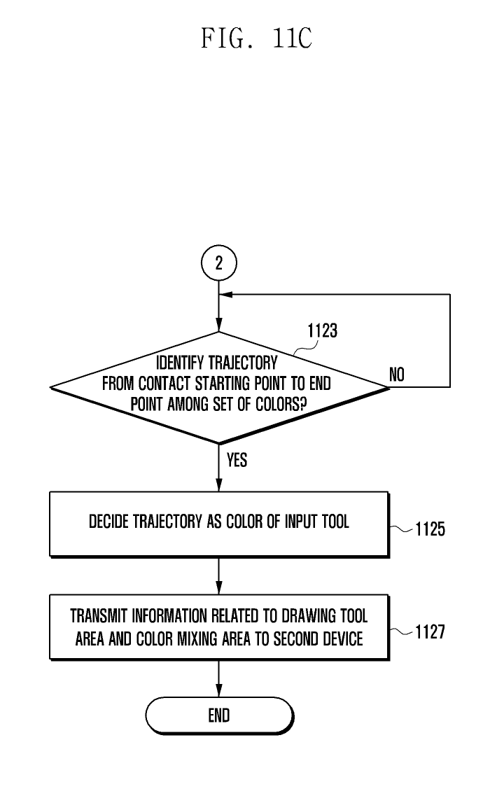

FIGS. 11A to 11C are flowcharts illustrating a process of selecting a method of controlling a color concentration when mixing colors in a portable terminal, according to an embodiment of the present invention.

Referring to FIG. 11A, the touch screen 140 displays the drawing tool area 141, including at least one color item and at least one drawing tool item at step 1101.

At step 1103, the touch screen 140 displays first and second color items selected from the drawing tool area 141 on the color mixing area 142 at step 1003. The selection of the first and second color items can be received by a user's selection input or by a previously stored method.

At step 1105, the controller 160 determines whether a mixing command for the first color item and the second color item displayed on the color mixing area 142 is received. This can include a mixing command by a user's touch or by an input tool 200 through a previously stored method. At step 1007, when it is determined that the mixing command is received, the touch screen 140 displays the mixed color of the first color item and the second color item, on the color mixing area 142.

Referring to FIG. 11B, the controller 160 determines whether a selection of a method of controlling a concentration of color to be mixed in the color mixing area 142 is received, at step 1109. For example, when method A is selected at step 1109, the controller 160 controls to change at least one of hue, brightness, saturation, or tone of the first color item to change the first color item into the second color item at step 1111. At step 1113, the touch screen 140 can display a set of colors which is a stepwise change of the first color item during the change into the second color item. Here, the stepwise change, i.e., the change from the first color item to the second color item can include a gradation effect.

Referring to FIG. 11C, at step 1123, the controller 160 identifies a trajectory drawn on the set of colors displayed on the touch screen 140. The trajectory is identified from a contact starting point, made by an input tool 200 or by a touch pressure, to a contact ending point, resulting from the release of contact made by the input tool 200 or the touch pressure. If a trajectory is identified, then at step 1125, the set of colors within the area of the identified trajectory is decided as the color of the input tool 200. The wireless communication unit 110 transmits information related to the drawing tool area 141 and the color mixing area 142 to the second device at step 1127. In this case, information related to the drawing tool area 141 and the color mixing area 142 can include information of changing at least one of hue, brightness, saturation, or tone of the first color item to the second color item, information of displaying a set of colors of the first color item, and information of deciding the trajectory as the color of the input tool 200.

According to another embodiment of the present invention, when method B is selected at step 1109, the controller 160 decides the ratio of concentration of the first color item to the second color item as a certain ratio and displays the ratio of the concentrations on the touch screen 140 at step 1115. The wireless communication unit 110 transmits the information related to the drawing tool area 141 and the color mixing area 142 to the second device 300 at step 1117. Here, the information related to the drawing tool area 141 and the color mixing area 142 can include information of the ratio of concentration of the first color item to the second color item.

According to another embodiment of the present invention, when method C is selected at step 1109, the controller 160 un-uniformly mixes the concentrations of the first color item and the second color item and displays the ratio of the concentrations on the touch screen 140 at step 1119. The wireless communication unit 110 transmits the information related to the drawing tool area 141 and the color mixing area 142 to the second device 300 at step 1121. In this case, the information related to the drawing tool area 141 and the color mixing area 142 can include information related to a non-uniform mixture of the first color item and the second color item.

In addition, at each step, it is not limited to the above-mentioned steps that the wireless communication unit 110 transmits the information related to the drawing tool area 141 and the color mixing area 142 to another device, e.g., the second device 300. The information related to the drawing tool area 141 and the color mixing area 142 can be transmitted by the wireless communication unit 110 in real time, and can be continuously updated and transmitted.

According to the embodiment of the present invention, a user can intuitively select and mix a color by using a graphical user interface for drawing. In addition, the graphical user interface for drawing can be expanded through a communication and connection with other devices.

Although embodiments of the present invention have been described in detail hereinabove, it should be clearly understood that many variations and modifications of the basic inventive concepts herein taught which can appear to those skilled in the present art will still fall within the spirit and scope of the present invention, as defined in the appended claims and their equivalents.

What is claimed is:

1. A drawing method in an electronic device, the method comprising:
displaying a drawing tool area, including at least one color item and at least one drawing tool item;
displaying, on a color mixing area, a first color item and a second color item selected from the drawing tool area;
determining whether a request signal for mixing the first color item and the second color item is received;
displaying, on the color mixing area, a mixed color generated by mixing the first color item and the second color item, when the request signal is received; and
transmitting information related to the drawing tool area and the color mixing area to a second device.

2. The method of claim 1, further comprising:
displaying a drawing area for displaying an image generated by using at least one of the at least one color item and the at least one drawing tool item.

3. The method of claim 2, wherein displaying the mixed color on the color mixing area comprises:
displaying the mixed color by controlling at least one of a concentration of the first color item and a concentration of the second color item.

4. The method of claim 3, wherein controlling the at least one of the concentration of the first color item and the concentration of the second color item comprises:
controlling a concentration ratio of the first color item and the second color item determined in a predetermined ratio.

5. The method of claim 3, wherein controlling the at least one of the concentration of the first color item and the concentration of the second color item comprises:
controlling a concentration ratio of the first color item and the second color item determined according to receiving a touch mixing event.

6. The method of claim 1, further comprising:
displaying and arranging the first color item and the second color item in separate locations;
changing at least one of hue data, brightness data, saturation data, and tone data of the first color item to generate the second color item; and
displaying and arranging a set of colors which is a stepwise change of the first color item based on changing the least one of hue data, brightness data, saturation data, and tone data of the first color item.

7. The method of claim 6, further comprising:
identifying a trajectory from a contact starting point to a contact ending point, drawn on the set of colors; and
determining a set of colors within the area of the trajectory as a color of an input tool.

8. The method of claim 2, further comprising:
transmitting information related to the drawing area to the second device.

9. The method of claim 8, wherein the electronic device displays at least one of the drawing tool area and the color mixing area, and the second device displays only the drawing area.

10. The method of claim 7, wherein determining the set of colors comprises:
selecting at least one color based on a size of the input tool.

11. The method of claim 3, wherein the first color item and the second color item are one of a pre-stored basic color and the mixed color.

12. An electronic device comprising:
a touch screen configured to:
display a drawing tool area, including at least one color item and at least one drawing tool item,
display, on a color mixing area, a first color item and a second color item selected from the drawing tool area, and
display a mixed color generated by mixing the first color item and the second color item on the color mixing area, when a request signal is received;
a controller configured to control the electronic device to receive the request signal for mixing the first color item and the second color item; and
a wireless communication unit configured to transmit information related to the drawing tool area and the color mixing area to a second device.

13. The electronic device of claim 12, wherein the touch screen is further configured to display a drawing area for displaying an image generated by using at least one of the at least one color item and the at least one drawing tool item.

14. The electronic device of claim 12, wherein the controller is further configured to control at least one of a concentration of the first color item and a concentration of the second color item, and the touch screen displays a mixed color based on the controlled concentration.

15. The electronic device of claim 14, wherein the controller is further configured to decide and controls a concentration ratio of the first color item and the second color item determined in a predetermined ratio.

16. The electronic device of claim 14, wherein the controller is further configured to control a concentration ratio of the first color item and the second color item determined according to receiving a touch mixing event.

17. The electronic device of claim 12, wherein the touch screen is further configured to display the first color item and the second color item in a separate locations, change at least one of hue data, brightness data, saturation data, and tone data of the first color item to generate the second color item, and display a set of colors which is a stepwise change of the first color item based on the change of at least one of hue data, brightness data, saturation data, and tone data of the first color item.

18. The electronic device of claim 17, further comprising:
an input tool to output a set of colors identified by a trajectory from a contact starting point to a contact ending point, drawn on the set of colors.

19. The electronic device of claim 13, wherein the wireless communication unit is further configured to transmit information related to the drawing area to the second device.

20. The electronic device of claim 19, wherein the second device receives information related to the drawing tool area, the color mixing area, and the drawing area, and displays the drawing area based on the received information.
